(19) United States
(12) Patent Application Publication
(10) Pub. No.: US 2026/0176998 A1
(43) Pub. Date: Jun. 25, 2026

(54) MULTI-STAGE EXHAUST AFTER-TREATMENT DEVICE WITH COMPACT CONFIGURATION AND METHODS OF MANUFACTURING, INSTALLING, AND USING THE SAME

(71) Applicant: Daimler Truck North America LLC, Portland, OR (US)

(72) Inventors: David HORNING, Detroit, MI (US); Matthew OAKS, Detroit, MI (US); Joshua SCHMIDT, Portland, OR (US); Jonathan MCKNIGHT, Portland, OR (US)

(21) Appl. No.: 19/431,669

(22) Filed: Dec. 23, 2025

Related U.S. Application Data
(60) Provisional application No. 63/738,322, filed on Dec. 23, 2024.

(51) Int. Cl. F01N 13/00; B01D 53/94; B01F 25/431; F01N 3/10; F01N 3/20; F01N 3/28

(52) U.S. Cl. CPC F01N 13/009; B01D 53/944; B01F 25/431; F01N 3/106; F01N 3/2066; F01N 3/2892; B01D 2251/208; B01D 2258/012; F01N 2610/02; F01N 2610/1453

(57) ABSTRACT

Multi-stage exhaust after treatment devices and compact arrangements of the same suitable for use in vehicles including diesel freight trucks. The multi-stage exhaust after-treatment device can include a first stage after-treatment component and a second stage after-treatment component that are connected by a transition chamber. The first stage after-treatment component and the second stage after-treatment component can be distinct enclosures shaped, arranged, and attached to form a vertically-stacked configuration with a non-linear upper pathway for exhaust after-treatment and a non-linear lower pathway for exhaust after-treatment that is additionally complemented by mixing in the transition chamber. Methods of manufacturing, integrating, and using such devices are also provided.

### CROSS-REFERENCE TO RELATED APPLICATIONS

The present application claims priority to, and the benefit of, U.S. Provisional Application No. 63/738,322, filed Dec. 23, 2024, which is incorporated by reference herein in its entirety.

### TECHNICAL FIELD

The field relates to exhaust after-treatment devices, e.g., for diesel engines.

### BACKGROUND

Exhaust after-treatment devices are incorporated into vehicles to help reduce emissions and meet regulatory requirements. Exhaust after-treatment devices typically expose exhaust gases to materials and/or treatments that convert or at least partially eliminate certain undesired emissions, e.g., nitrogen oxide (NOX), carbon monoxide, hydrocarbons, and the like. However, due to the limited space available for exhaust after-treatment devices in modern vehicles, and due to increasing regulatory requirements for the reduction of vehicle emissions, there are challenges in incorporating exhaust after-treatment devices that meet desired performance parameters while also fitting into available space.

### SUMMARY

In brief, and at a high-level, disclosed herein are multi-stage exhaust after-treatment devices designed to have a compact configuration. The devices can provide enhanced multi-stage reduction of undesired emissions in exhaust generated by an attached engine, while also being incorporated into a more compact internal space inside a vehicle, among other benefits.

In aspects, a multi-stage exhaust after-treatment device includes a first stage after-treatment component comprising a plurality of exhaust treatment sections extending along a non-linear path, including a diesel exhaust fluid injector configured to inject diesel exhaust fluid; and a second stage after-treatment component positioned downstream of the first stage after-treatment component having a diesel oxidation catalyst; wherein the first stage after-treatment component is attached over a top surface of the second stage after-treatment component; and a transition chamber fluidly connecting the first stage after-treatment component to the second stage after-treatment component so as to allow exhaust from the first stage after-treatment component to be communicated to the second stage after-treatment component

In aspects, a multi-stage exhaust after-treatment device includes multiple distinct exhaust after-treatment stages that are attached together and arranged in a series. Having multiple stages of exhaust after-treatment can allow a greater amount of emissions reduction to occur and/or can allow different or additional types of emissions reduction to occur using a single device. The distinct exhaust after-treatment stages can be arranged in a physically compact, e.g., vertically-stacked or vertically-mated, configuration. This allows the device to be incorporated into a smaller space, e.g., a compartment inside a vehicle, e.g., one that may otherwise be designed for a more traditional single-stage exhaust after-treatment device, and/or one that may otherwise not have adequate space for a larger, more distributed, and/or more linearly arranged multi-stage exhaust after-treatment device. This supports greater emissions reduction, efficient use of space, and in some instances, limited modification to existing engines, exhaust pathways, and internal arrangements inside vehicles, among other benefits.

In aspects, a multi-stage exhaust after-treatment device includes a first stage after-treatment component; a second stage after-treatment component, and a transition chamber. The transition chamber connects the first stage and the second stage, allowing exhaust gases to transfer from the first stage to the second stage. In some aspects, the first stage and the second stage can provide similar types of emissions reduction, e.g., dosing, material exposure, and the like. In some aspects, the first stage and the second stage can provide distinct types of emissions reduction, e.g., dosing, material exposure, and the like, e.g. for increased or more targeted emissions reduction. In aspects, the first stage and the second stage are distinct enclosures that are fixed to each other, e.g., attached together in a vertically-stacked, enclosing, mated, and/or enveloping configuration.

In some aspects, the first stage is secured at least partially over, on top of, and/or against the second stage, e.g., through use of physical attachments, e.g., fasteners, brackets, flanges, straps, welding, or the like. In some aspects, a plurality of exhaust treatment sections of the first stage can be arranged to extend in a non-linear path, e.g., about a top surface of the second stage, to increase a distance along which exhaust treatment can occur while still allowing the device to remain volumetrically compact. The transition chamber can additionally be shaped, positioned, and configured to enhance emissions reduction and facilitate the transfer of exhaust from the first stage, e.g., and its upper exhaust pathway, to the second stage, e.g., and its lower exhaust pathway, with limited use of space.

In aspects, a vehicle that includes a multi-stage exhaust after-treatment device according to aspects herein is provided. In aspects, the vehicle can be a diesel-powered freight truck.

In aspects, a method of manufacturing, installing, and using a multi-stage exhaust after-treatment device according to aspects herein is provided.

In aspects, a method of operating a vehicle or a method of operating a fleet of vehicles that each incorporate a multi-stage exhaust after-treatment device according to aspects herein is provided.

The aspects described herein can help improve the ability to incorporate a multi-stage exhaust after-treatment device into various types of existing or new combustion-powered vehicles, can help overall limit the need for modification to existing exhaust systems and technologies, and can help vehicle operators reduce emissions and meet regulatory requirements and improve the sustainability of vehicle operations, among other benefits.

This summary is intended to introduce a selection of concepts in a simplified form that are further described below in the detailed description section of this disclosure. This summary is not intended to identify key or essential features of the claimed subject matter, nor is it intended to be used as an aid in isolation to determine the scope of the claimed subject matter.

### BRIEF DESCRIPTION OF THE DRAWINGS

Multi-stage exhaust after-treatment devices and methods of manufacturing, installing, and using the same are described herein in connection with the attached figures which depict non-limiting examples of the present subject matter:

FIG. 1 depicts a multi-stage exhaust after-treatment device, according to aspects of the present disclosure;

FIG. 2A depicts a first stage after-treatment component of the multi-stage exhaust after-treatment device of FIG. 1, according to aspects of the present disclosure;

FIGS. 2B-2D depict distinct exhaust treatment sections of the first stage after-treatment component shown in FIG. 2A, according to aspects of the present disclosure;

FIGS. 3A-3F depict a second stage after-treatment component forming part of the device shown in FIG. 1, according to aspects of the present disclosure;

FIG. 4 depicts a cross-section of a transition chamber that connects stages of the device shown in FIG. 1, according to aspects of the present disclosure;

FIG. 5 depicts one type of vehicle that can incorporate the multi-stage exhaust after-treatment device shown in FIG. 1, according to aspects of the present disclosure;

FIG. 6 depicts a method of manufacturing a multi-stage exhaust after-treatment device, according to aspects of the present disclosure; and

FIG. 7 depicts a method of installing a multi-stage exhaust after-treatment device in a vehicle, according to embodiments of the present disclosure.

### DETAILED DESCRIPTION

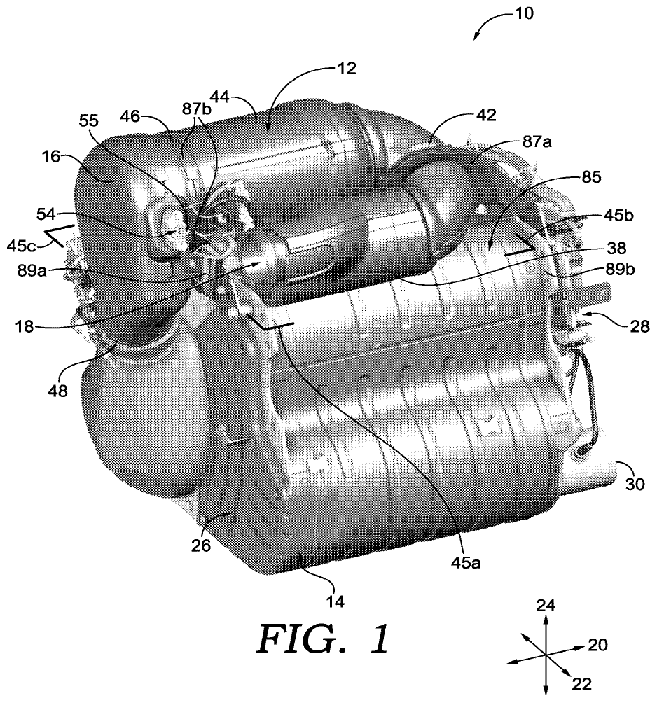

In general, provided herein are multi-stage exhaust after-treatment devices that include a series of exhaust after-treatment stages joined together by at least one transition chamber, with the device and components thereof arranged into a compact and non-linear assembly that can be installed and operated inside a compartment of a vehicle for enhanced reduction of undesired emissions and space efficiency. In addition, provided herein are vehicles that include such devices. In addition, provided herein are methods of manufacturing, installing, and using the aforementioned multi-stage exhaust after-treatment devices, e.g., in vehicles or fleets of vehicles, e.g., freight vehicles. Examples of the present subject matter are discussed in detail below in connection with attached FIGS. 1-7.

Referring to FIG. 1, a multi-stage exhaust after-treatment device 10 is shown, according to aspects of the present disclosure. The multi-stage exhaust after-treatment device 10 includes a first stage after-treatment component 12 (that can also be referred to as a pre-treatment device) and includes a second stage after-treatment component 14 (that can also be referred to as a main treatment device, main enclosure, or main box) that is downstream of the first stage after-treatment component 12. These components 12, 14 are distinct enclosures and pathways that are attached together to form a unified, compact configuration of the device 10, e.g., with components 12, 14 vertically-stacked as shown in FIG. 1. This allows the device 10 to maintain a compact configuration that more readily fits into compact spaces inside a vehicle, while also providing a longer pathway for treating emissions in exhaust passing through the device 10. The device 10 also includes a transition chamber 16 that connects together the first and second stage after-treatment components 12, 14. In operation, exhaust enters the device 10 at the exhaust inlet 18, and then the exhaust passes through the first stage after-treatment component 12, passes through the transition chamber 16, and then passes through the second stage after-treatment component 14. Once treated for undesired emissions the exhaust exits the device 10 at the outlet 30.

FIG. 1 depicts the multi-stage exhaust after-treatment device 10 in relation to a longitudinal axis 20, a lateral axis 22, and a vertical axis 24 which are identified in FIG. 1 for reference purposes. The exhaust inlet 18 is located proximate to a forward end 26 of the device 10. The device 10 also includes the exhaust outlet 30 located proximate to a rear end 28 of the device 10 that is opposite to the forward end 26. The exhaust inlet 18 and the exhaust outlet 30 are offset along the vertical axis 24 due to the vertically-stacked configuration of the first and second stage after-treatment components 12, 14.

FIG. 1 depicts the orientation of the multi-stage exhaust after-treatment device 10 as it would be installed inside a vehicle, e.g., with the component 12 fixed and/or attached on top of the component 14. In this orientation, the component 12 is closer to a top of the vehicle, the component 14 is closer to a bottom of the vehicle, the forward end 26 is closer to a front end of the vehicle, and the rear end 28 is closer to a back end of the vehicle. In the installed position, the exhaust inlet 18 attaches to an exhaust manifold of an engine positioned proximate to the forward end 26 of the device 10. Exhaust generated by the engine can then be communicated through a flow path of the device 10 that extends through the first stage after-treatment component 12, through the transition chamber 16, through the second stage after-treatment component 14, and then through the exhaust outlet 30 where the treated exhaust can then exit the exhaust system into the atmosphere. FIG. 1 shows how the first stage after-treatment component 12 and components thereof provides an upper exhaust pathway (e.g., where a first emissions reduction occurs), the transition chamber vertically transfers the exhaust to the second exhaust-after treatment component 14, and the second exhaust-after treatment component 14 and components thereof provides a lower exhaust pathway (e.g., where a second emissions reduction occurs). The device 10 provides a multi-directional non-linear pathway that enables a greater distance and by association greater capacity for reducing undesired emissions in the exhaust passing through the device 10 while at the same remaining volumetrically compact. Herein, for reference, the longitudinal, lateral, and vertical axes 20, 22, 24 in FIG. 1 may be referred to for orientation.

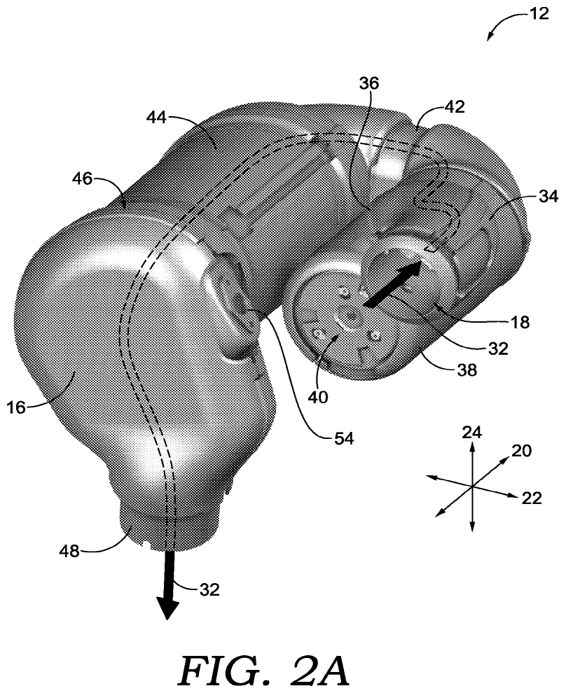

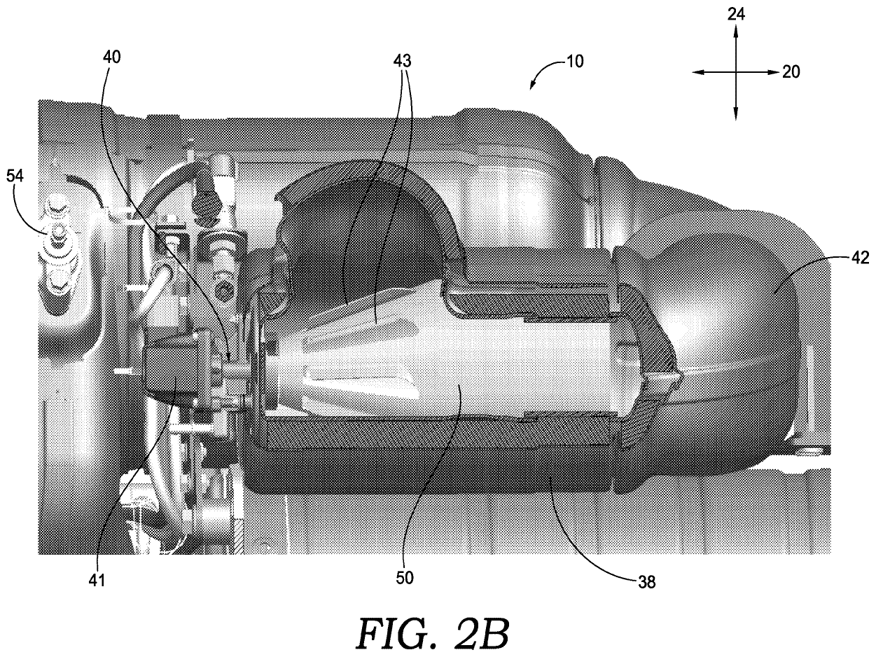

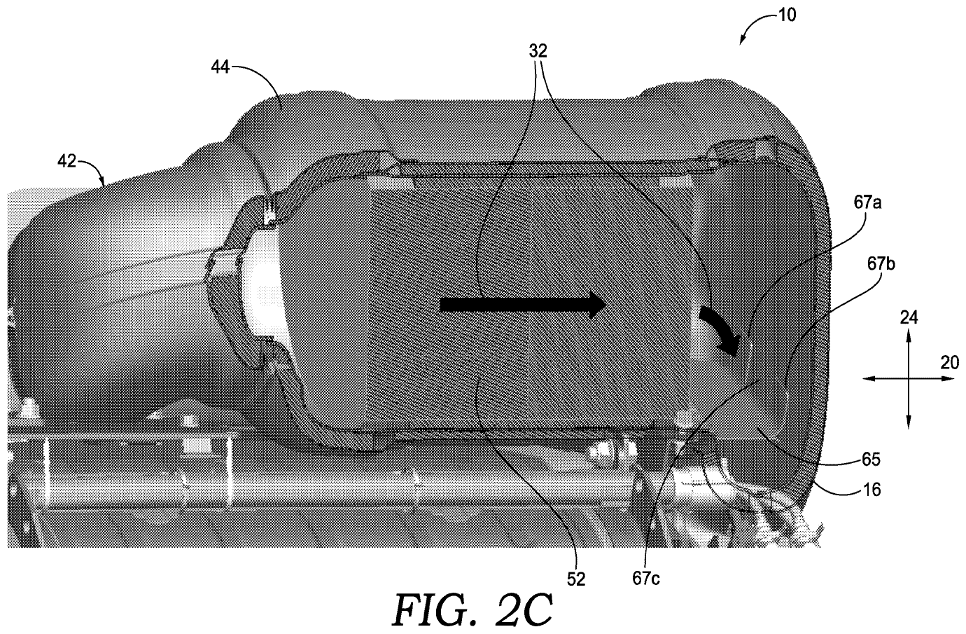

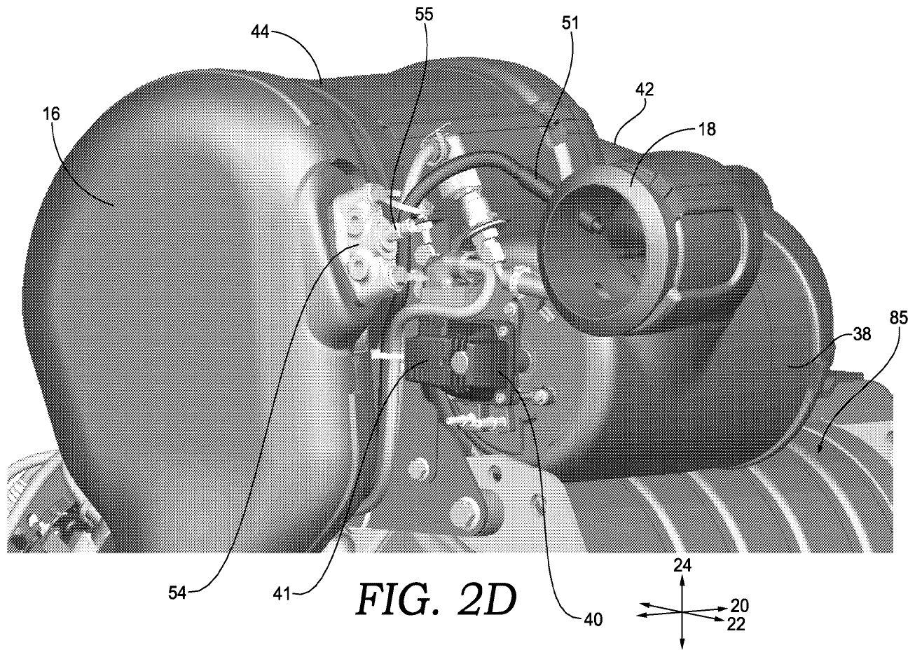

Referring to FIG. 2A, the first stage after-treatment component 12 of the multi-stage exhaust after-treatment device 10 of FIG. 1 is shown in isolation, in accordance with aspects of the present disclosure. FIG. 2A depicts the integrated components that together form the first stage after-treatment component 12 and that provide an exhaust flow path 32 through the first stage after-treatment component 12. These integrated components include the exhaust inlet 18. The exhaust inlet 18 attaches to an exhaust manifold that communicates exhaust from an attached engine that is operating. From the exhaust inlet 18, a conduit 34 extends to an inlet 36 of an exhaust treatment section 38 of the first stage after-treatment component 12. FIG. 2A depicts how the conduit 34 extends non-linearly from the exhaust inlet 18 and curves toward the inlet 36. To state it differently, as shown in FIG. 2A, an axis of the exhaust inlet 18 and an axis of the inlet 36 are offset and also are oriented at a non-parallel angle to each other, such that the conduit curves from an outwardly-spaced location to an inwardly-spaced location, e.g., closer to the device 10 and top surface 85 thereof shown in FIG. 1. This allows exhaust to enter the component 12 at an origin but then transition to a more inward location to help maintain a compact configuration and allow the overall device 10 to fit into a smaller space.

Looking still at FIG. 2A, the flow path 32 (internally identified by the dotted line) continues from the inlet 36 into the exhaust treatment section 38. In aspects, the exhaust treatment section 38 can be configured to impart one or more types of emissions reduction. In this example, the exhaust treatment section 38 is configured so that diesel exhaust fluid can be injected into the exhaust passing through the exhaust treatment section 38. This injection is provided by a diesel exhaust fluid injection component 40 (depicted in FIG. 2A without an injector 41 that is depicted in the installed position in FIG. 2B). This injection of diesel exhaust fluid, like the injection of other emissions reducing substances into the device 10, can be controlled by an actuator and can be based on sensor feedback, e.g., sensor feedback indicating mass/volumetric flow rate, emissions concentration, particulate concentration, temperature, or the like.

In the installed position shown in FIG. 1, the exhaust treatment section 38 extends generally across the top surface 85 of the component 14 and generally along the longitudinal axis 20 as identified in FIG. 1. The exhaust treatment section 38 then connects to another exhaust treatment section 42 that extends from the exhaust treatment section 38 generally across the top surface 85 of the component 14 and generally along the lateral axis 22 as identified in FIG. 1. The exhaust treatment section 42 can in aspects also be configured to impart one or more types of emissions reduction to the exhaust therein. In this aspect, the exhaust treatment section 42 provides a conduit for diesel exhaust fluid hydrolysis to occur along the flow path 32. The exhaust treatment section 42 extends to an exhaust treatment section 44 that extends from the exhaust treatment section 42 generally across the top surface 85 of the component 14 and generally along the longitudinal axis 20 as identified in FIG. 1. The exhaust treatment section 44 can be configured to impart one or more types of emissions reduction. In this example, the exhaust treatment section 44 includes a catalyst therein that helps reduce emissions in the exhaust gases through exposing the exhaust gases to one or more catalyst substrates. FIGS. 1 and 2A depict how the non-linear arrangement, directionality, and sizing of the exhaust treatment sections 38, 42, 44 of the component 12 helps maintain volumetric compactness of the device 10 and also helps the component 12 maintain a lateral footprint (e.g., about axes 20, 22) that is similar to the lateral footprint of the component 14.

The exhaust treatment sections 38, 42, 44 generally form a U-shaped configuration. This helps maintain a compact, space-efficient arrangement on the top surface 85 of the component 14. In aspects, e.g., as shown in FIG. 2A, the exhaust treatment sections 38, 42, 44 can be configured to at least partially mateably shape-to, enclose, engage, and/or cover the top surface 85 of the component 14 as depicted in FIG. 1. In FIG. 1, the exhaust treatment sections 38, 42, 44 also extend about the top surface 85 such as to substantially remain with a lateral perimeter (e.g., substantially within perimeter boundaries 45a, 45b, 45c as identified in FIG. 1) of the component 14. FIG. 2A depicts in addition how the diameter and/or cross-sectional area and/or cross-sectional area of the flow path 32 at a particular section 38, 42, 44 in the component 12 changes to accommodate the type of exhaust treatment being used, e.g., to help facilitate a lower pressure drop and lower back-pressure and an overall higher volumetric flow rate through the device 10.

Referring to FIG. 2A, the transition chamber 16 is shown. The transition chamber 16 connects to an outlet 46 of the first after-treatment component 12 and extends the flow path 32 to the second after-treatment component 14. The transition chamber 16 has a changing diameter and/or cross-sectional area along the flow path 32. In the aspect of FIG. 2A, the transition chamber 16 has a first diameter and/or cross-sectional area proximate to the outlet 46 and a second diameter and/or cross-sectional area proximate to an inlet 48 of the second after-treatment component 14, the second diameter and/or cross-sectional area being smaller than the first diameter and/or cross-sectional area. The change in the diameter and/or cross-sectional area and geometry of the transition chamber 16 allows exhaust gases in the flow path 32 to initially decelerate and disperse inside the transition chamber 16 (e.g., for enhanced mixing) and then, due to the reducing diameter and/or cross-sectional area, accelerate towards the inlet 48 for higher velocity introduction into the second stage after-treatment component 14. To facilitate additional emissions reduction, an injection device 54 is attached to the transition chamber 16 for introducing emissions reducing substances into the transition chamber 16. FIG. 2A shows the injection device 54 with an injector 55 removed but the injector 55 is shown in FIG. 1. In aspects, the injection device 54 can be used to introduce hydrocarbons that are evaporated and mixed into exhaust gas that flows through the transition chamber 16 and into the second stage after-treatment component 14.

The transition chamber 16 is oriented so that initially the flow path 32 enters substantially along the longitudinal axis 20 as identified in FIG. 1, and then the flow path 32 transitions to extend substantially along the vertical axis 24 as identified in FIG. 1. In addition, some transition of the flow path 32 along the lateral axis 22 additionally occurs in the transition chamber 16. This configuration of the transition chamber 16 allows the flow path 32 to remain closely aligned with the top surface 85 and also the forward end 26 of the device 10 to help maximize volumetric efficiency and also helps provide a length of the flow path 32 that is needed for desired reduction of emissions. The transition chamber 16 can be secured at one or multiple locations to the device 10, e.g., at the outlet 46, at the inlet 48, adjacent to the top surface 85, and/or elsewhere using the attachment methodologies described herein.

Referring to FIG. 2B, a cross-section of the exhaust treatment section 38 that forms part of the first stage after-treatment component 12 of the device 10 is shown, according to aspects of the present disclosure. FIG. 2B depicts the diesel exhaust fluid injection component 40 and its injector 41 configured for injecting diesel exhaust fluid into an interior of the exhaust treatment section 38. FIG. 2B also depicts a mixer 50 inside the exhaust treatment section 38 that mixes exhaust gas with the diesel exhaust fluid injected by the injection component 40. The mixer 50 has a shape that increases in diameter and/or cross-sectional area along the flow path 32 and the mixer 50 also includes a plurality of vanes 43 for guiding the diesel exhaust fluid into the flow path of exhaust passing through the exhaust treatment section 38. The mixer 50 guides the exhaust mixture along the longitudinal axis 20 and towards a transition and turn to the exhaust treatment section 42 that extends along the lateral axis 22 as shown in FIG. 1. The exhaust treatment section 42 is where hydrolysis of the diesel exhaust fluid injected into the exhaust treatment section 38 can then occur.

Referring to FIG. 2C, a cross-section of the exhaust treatment section 44 of the device 10 is shown, according to aspects of the present disclosure. FIG. 2C is looking laterally at the exhaust treatment section 44 but from an opposite side as FIG. 2B. The exhaust treatment section 44 shown in FIG. 2C as described herein includes a catalyst component used to reduce undesired emissions in exhaust gases passing through the exhaust treatment section 44. More specifically, as shown in FIG. 2C, the exhaust treatment section 44 includes one or more catalyst substrates 52 positioned inside a conduit of the exhaust treatment section 44. The catalyst substrate(s) 52 interact with exhaust gases passing through the exhaust treatment section 44 to reduce undesired emissions. FIG. 2C shows how, at the transition from the exhaust treatment section 42 to the exhaust treatment section 44, the diameter and/or cross-sectional area of the flow path 32 increases to allow the exhaust gases to be exposed to a greater cross-sectional area of the substrate(s) 52. This helps facilitate enhanced reduction of undesired emissions in a smaller length of the exhaust treatment section 44. FIG. 2C further depicts, internal to the exhaust treatment section 44, a transition plate 65 that directs the flow path 32 into the transition chamber 16. The transition plate 65 includes a pair of flanges 67a, 67b that extend upward generally perpendicular to the flow path 32 and also includes an opening 67c through which exhaust gases can flow into the transition chamber 16.

Referring to FIG. 2D, another enhanced depiction of the first stage after-treatment component 12 of the device 10 is shown, according to aspects of the present disclosure. FIG. 2D depicts the exhaust inlet 18, the exhaust treatment section 38, part of the exhaust treatment section 42, the exhaust treatment section 44, and the upstream portion of the transition chamber 16. FIG. 2D depicts an emissions sensor 51, e.g., in this case an NOx sensor, located at the exhaust inlet 18. The emissions sensor 51 can be used for monitoring emissions levels in exhaust entering the first stage after-treatment component 12 via the exhaust inlet 18. FIG. 2D also shows the diesel exhaust fluid injection component 40 and its injector 41. FIG. 2D also shows the injection device 54 and its injector 55 that can be used to inject hydrocarbons into the transition chamber 16.

Referring to FIGS. 1 and 2D, it can be seen how the first stage after-treatment component 12 is fixed, attached, and/or secured on top of the second stage after-treatment component 14, e.g., relative to the vertical axis 24. In particular, the component 12 is secured at least partially on, over, and/or against the top surface 85 of the component 14 such that the components 12, 14 are fixedly attached to each other and form an abutting, vertically-stacked, and at least partially mated configuration. To secure this configuration, a series of brackets 87a, 87b are coupled around the first after-treatment component 12 and in particular around the exhaust treatment sections 42, 44 thereof. The brackets 87a, 87b are further attached to flanges 89a, 89b extending from the top surface 85 of the second stage after-treatment component 14. In aspects, e.g., as shown in FIG. 1, a series of fasteners can be used to connect the brackets 87a, 87b to the flanges 89a, 89b. This configuration allows the components 12, 14 to remain fixedly attached along the vertical axis 24.

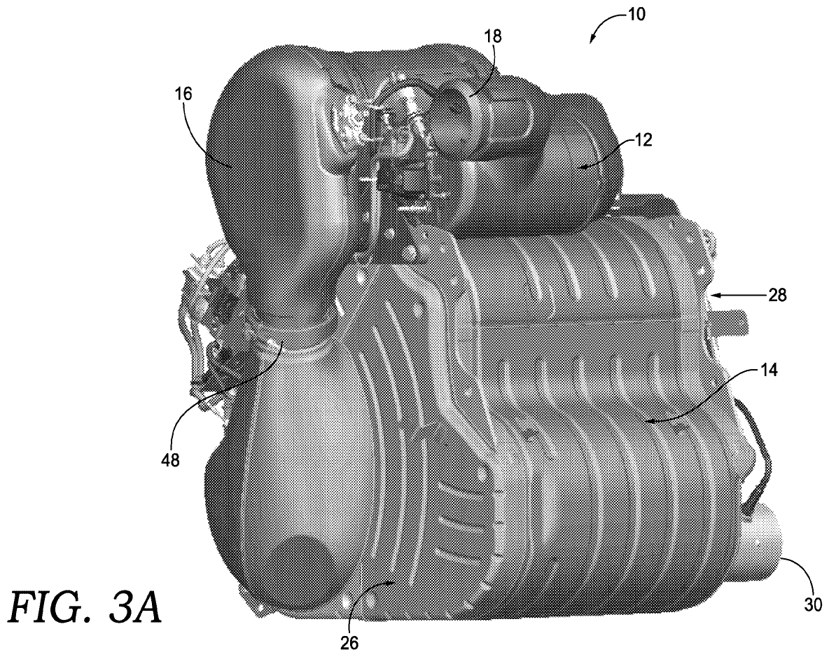

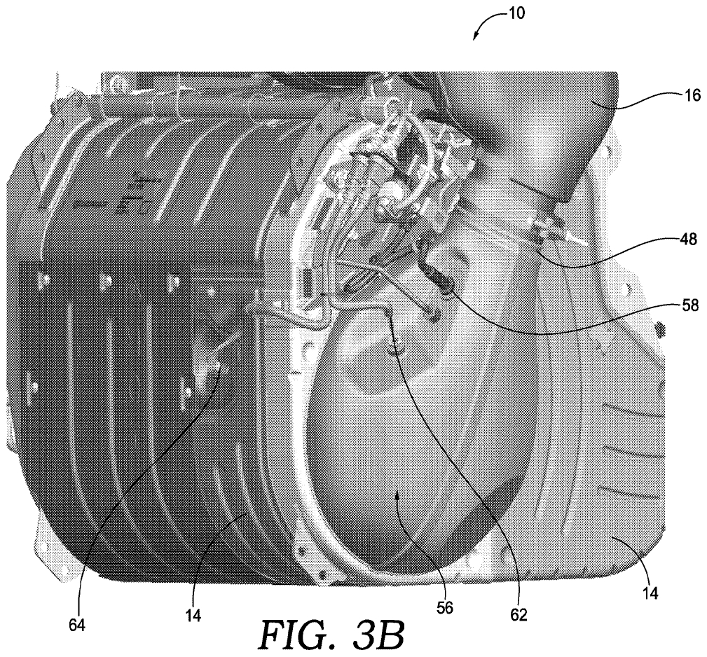

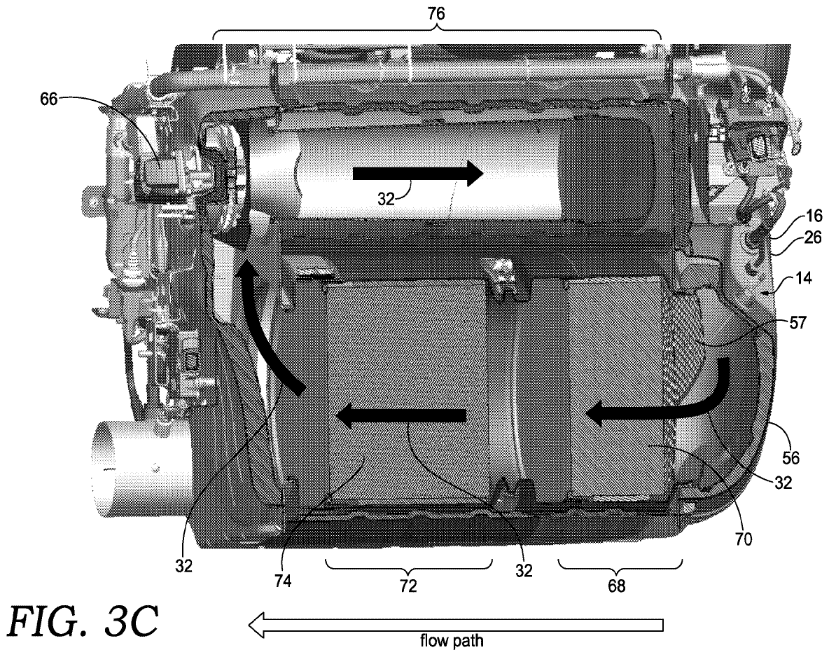

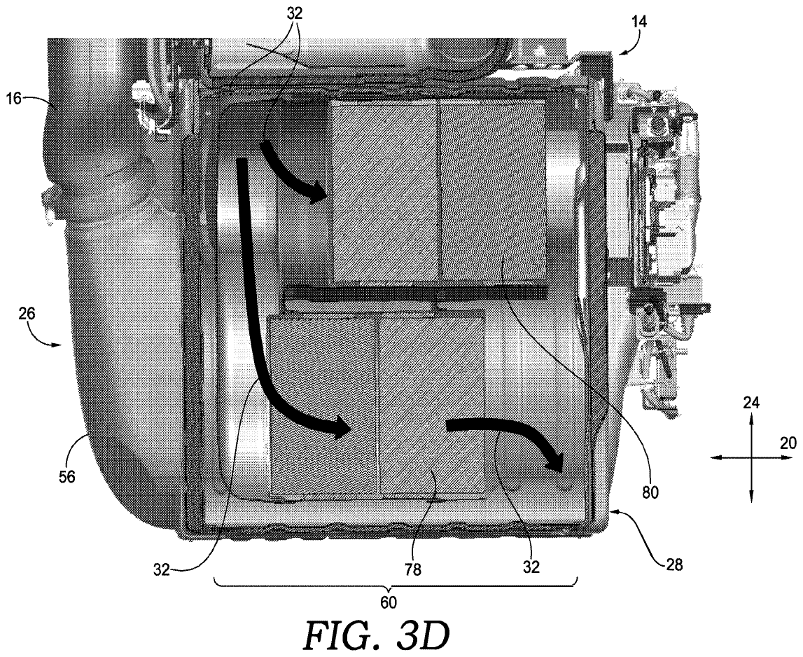

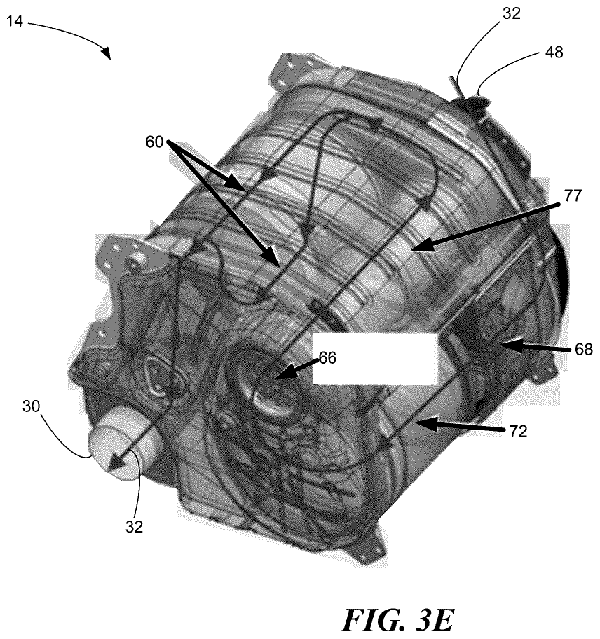

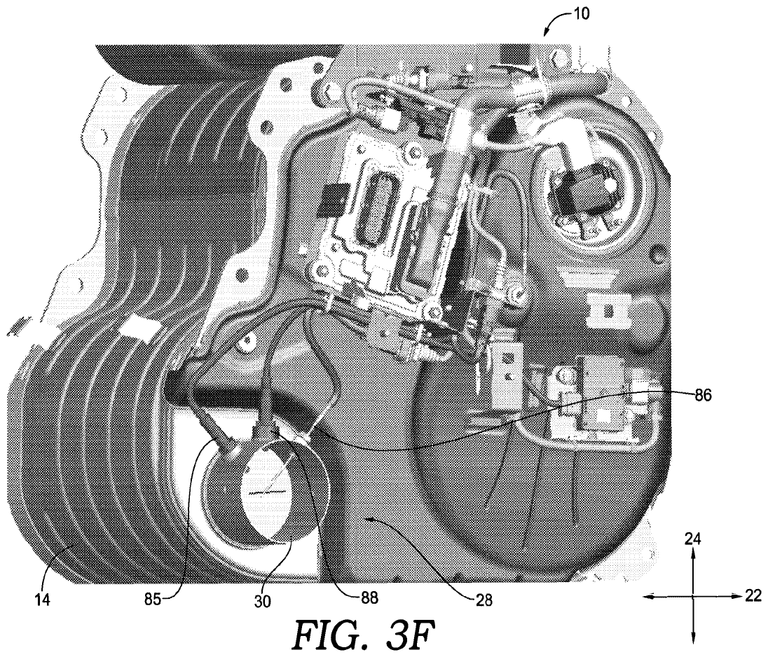

Referring to FIGS. 3A-3F, different components and sections of the second stage after-treatment component 14 are shown, according to aspects of the present disclosure. FIG. 3A depicts primarily a forward end 26 of the device 10. In addition, FIG. 3A depicts the transition chamber 16 extending to an inlet 48 of the second stage after-treatment component 14. Referring to FIG. 3B, another perspective of the forward end 26 of the device 10 is shown. FIG. 3B in particular shows how the inlet 48 transitions to an expansion section 56 where the interior volume increases in the transition towards the interior of the second stage after-treatment component 14. FIG. 3B also depicts additional components that support operation of the second stage after-treatment component 14 and the device 10. In particular, as shown in FIG. 3B, attached to the expansion section 56 is an emissions sensor 58, e.g., in this example a NOx sensor for measuring NOx levels of exhaust entering the second stage after-treatment component 14. In addition, in this aspect, a sensor 62 is attached to the expansion section 56, e.g., in this instance the sensor 62 is a temperature sensor that measures a temperature of exhaust gases entering the second stage after-treatment component 14. In addition, in this aspect, a sensor 64, e.g., a temperature sensor, is positioned at a downstream point in the second stage after-treatment component 14 for measuring a temperature of exhaust passing through exhaust treatment sections of the second stage after-treatment component 14. The selection, position, number, and type of sensors used on the device 10 in aspects can be modified based on desired feedback at desired locations and the sensors on the device 10 are intended to represent one non-limiting configuration. Monitoring conditions (e.g., temperature) and composition (e.g., presence of particular types of undesired emissions) with sensors can provide feedback that can be used to modify and optimize the operation of the device 10.

Referring to FIG. 3C, a cross-section of part of the second stage after-treatment component 14 of the device 10 is shown, according to aspects of the present disclosure. Initially, exhaust gases exit the expansion chamber 56, pass through a screen filter 57, and then transition into a flow path 32 through the second stage after-treatment component 14. The flow path 32 initially extends through an exhaust treatment section 68 that in this example includes a catalyst 70 (e.g., a diesel oxidation catalyst) for reducing emissions in the exhaust passing through the exhaust treatment section 68. The exhaust then passes through an exhaust treatment section 72 that includes a filter 74 (e.g., a diesel particulate filter) for reducing particulates in the exhaust passing through the exhaust treatment section 72. The exhaust then continues along the flow path 32 and transitions into an exhaust treatment section 76 that includes an injection component 66, e.g., a DEF injection point, that doses and mixes diesel exhaust fluid into the exhaust passing through the exhaust treatment section 76 to reduce undesired emissions in the exhaust gases within the exhaust treatment section 76.

Referring to FIG. 3D, a cross-section of the opposite side of the second stage after-treatment component 14 compared to FIG. 3C is shown, according to aspects of the present disclosure. FIG. 3D depicts part of the flow path 32 downstream of the components described in connection with FIG. 3C. In other words, the flow path 32 transitions from the exhaust treatment section 76 shown in FIG. 3C to the components shown in FIG. 3D. Upon entering the exhaust treatment section 60 shown in FIG. 3D, exhaust gases subsequently split into parallel paths and pass through catalyst substrates 78, 80 that reduce undesired emissions in the exhaust inside the exhaust treatment section 60.

Referring to FIG. 3E, a rear perspective view of the second stage after-treatment component 14 including a line with arrows identifying the flow path 32 into the inlet 48, through the second after-treatment component 14 as described in FIGS. 3C and 3D, and out of the exhaust outlet 30.

Referring to FIG. 3F, a perspective view of the rear end 28 of the second stage after-treatment component 14 is shown, according to aspects of the present disclosure. FIG. 3F in particular shows the configuration of components proximate to the exhaust outlet 30 where exhaust gases from the exhaust treatment section 60 exit the second stage after-treatment component 14 into a tailpipe. The exhaust outlet 30 includes sensors for detecting conditions of the exhaust exiting through the exhaust outlet 30 to determine if a desired reduction of undesired emissions is occurring during operation of the device 10. For example, as depicted in FIG. 3F, in aspects, these sensors can include a temperature sensor 86 that measures a temperature of exhaust gases passing through the exhaust outlet 30; can include a soot or larger particulate sensor 88 that measures for larger particles passing through the exhaust outlet 30, and/or can include a NOx sensor 95 that measures a level of NOx in exhaust gases passing through the exhaust outlet 30. This configuration is depicted as an example. In aspects, additional or alternative sensors can be used.

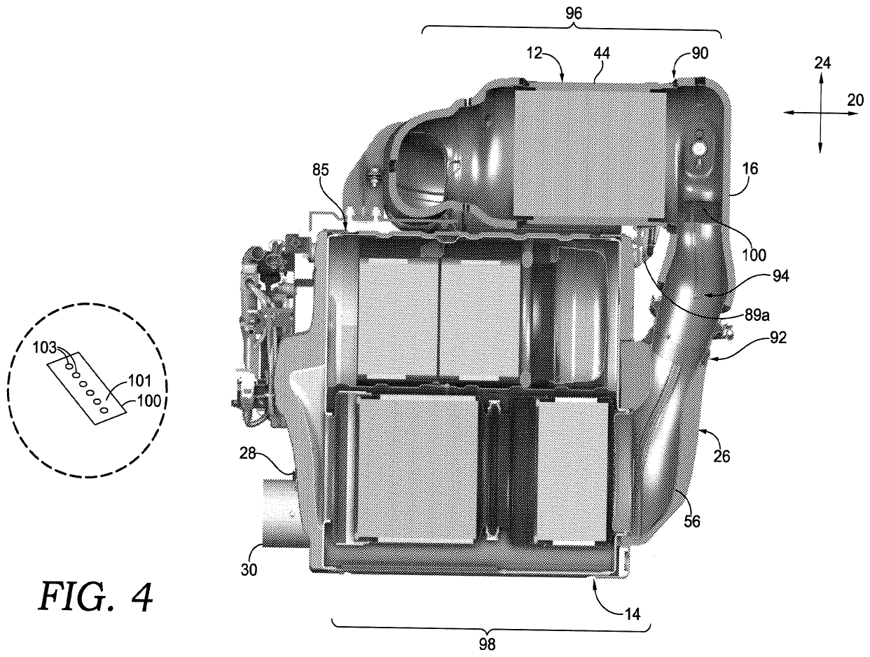

Referring to FIG. 4, a cross-section of the device 10 and in particular a cross-section of the transition chamber 16 is shown, according to aspects of the present disclosure. FIG. 4 shows how the transition chamber 16 is configured to communicate exhaust from the exhaust treatment section 44, through an inlet 90 of the transition chamber 16, through a conduit 94 of the transition chamber 16, and to an outlet 92 of the transition chamber 16 where the exhaust can then flow into the expansion chamber 56. The conduit 94 extends along a non-linear path and includes a changing cross-sectional area as shown in FIG. 4 and in FIG. 1. In addition, the transition chamber 16 shifts from being oriented generally along the longitudinal axis 20, as shown in FIG. 1 and FIG. 4, to being oriented generally along the vertical axis 24, e.g., as shown in FIG. 4, as the conduit 94 extends downward along the forward end 26 of the stage second after-treatment component 14. The transition chamber 16 thus directs exhaust gases from the exhaust treatment section 44 closely along the top surface 85 of the component 14 and around onto the forward end 26 until the exhaust gases reach the expansion chamber 56 and then subsequently transfer into the second stage after-treatment component 14. This non-linear path helps enable a desired length and number of exhaust treatment sections to be incorporated into both an upper exhaust pathway 96 of the device 10 and a lower exhaust pathway 98 of the device 10. The transition chamber 16 allows for a directionally efficient transfer of exhaust between the upper and lower exhaust pathways 96, 98 along with facilitating additional mixing, emissions monitoring, and emissions reduction.

Looking still at FIG. 4, the transition chamber 16 changes from a larger diameter and/or cross-sectional area at the inlet 90 to a smaller diameter and/or cross-sectional area at the outlet 92. The smaller diameter and/or cross-sectional area at the outlet 92 helps with accelerating the flow of exhaust gases entering the second stage after-treatment component 14. To facilitate mixing, the transition chamber 16 includes a mixing structure 100 therein (additionally shown outside of the device 10 in FIG. 4). The mixing structure 100 helps mix exhaust and hydrocarbons introduced by the injection device 54. The mixing structure 100 is shaped to enhance mixing, turbulence, and homogeneity of gases in the transition chamber 16. To accomplish this, the mixing structure 100 can have different configurations and the design shown in FIG. 4 is one example. In the depicted aspect, the mixing structure 100 is a plate 101 that includes a plurality of holes 103 through which fluid can pass to enhance mixing. In aspects, and as depicted in FIG. 4, the transition chamber 16 and expansion chamber 56 can be sized, shaped, and contoured to reduce pressure drops and thereby provide more efficient operation and throughput in the device 10.

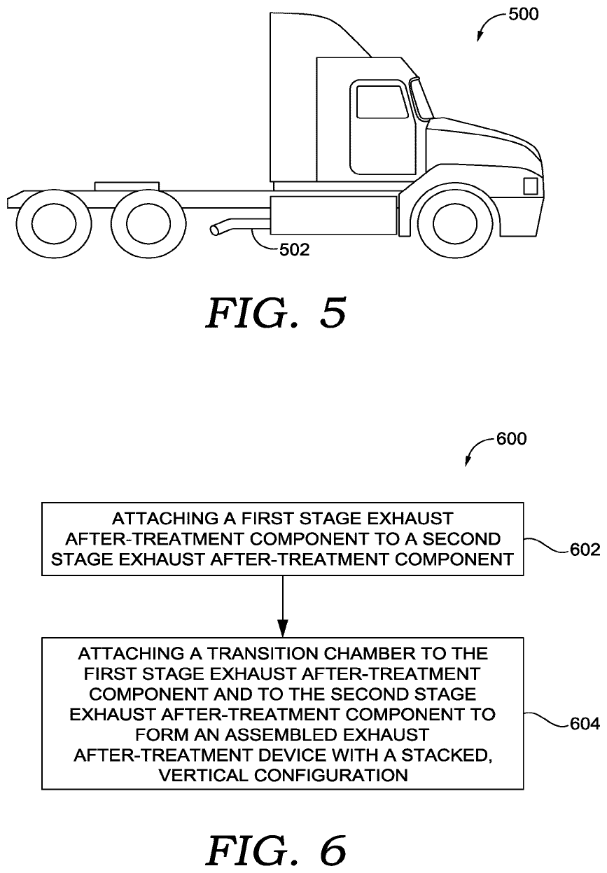

Referring to FIG. 5, an example vehicle 500 that can incorporate a multi-stage exhaust after-treatment device, e.g., such as the device 10 of FIG. 1, is shown, according to aspects of the present disclosure. The vehicle 500 is depicted as a freight truck, e.g., a diesel-powered freight truck. However, other types of vehicles having a multi-stage exhaust after treatment device incorporated therein are also contemplated, e.g., including cars, trains, trams, construction equipment or machinery, or other combustion-powered transports. In aspects, a truck that is gasoline powered, diesel powered, or hybrid combustion-electric powered may incorporate a multi-stage exhaust after-treatment device as described herein.

FIG. 6 depicts a block diagram of a method 600 of manufacturing a multi-stage exhaust after-treatment device, e.g., such as the device 10, according to aspects of the present disclosure. The method 600 includes blocks 604-604 but is not limited to such elements or the order shown. In block 602, the method 600 includes attaching a first stage exhaust after-treatment component, e.g., such as the component 12 shown in FIG. 1, to a second stage exhaust after-treatment component, e.g., such as the component 14 shown in FIG. 1. In block 604, the method 600 includes attaching a transition chamber, e.g., such as the transition chamber 16, to the first stage after-treatment component and to the second stage after-treatment component to form an assembled exhaust after-treatment device with a stacked, vertical configuration. For example, the configuration can be such that an exhaust flow path extends through an upper exhaust pathway through the first stage after-treatment device, e.g., such as upper exhaust pathway 96 in FIG. 4, through the transition chamber, and then through a lower exhaust pathway through the second stage after-treatment device, e.g., such as lower exhaust pathway 98 in FIG. 4, as it relates to a vertical axis in an installed position. In aspects, the first stage after-treatment component can be positioned on, over, and/or against a top surface of the second stage after-treatment component such that the first stage after-treatment component at least partially encloses, covers, and/or conforms to the top surface of the second stage after-treatment component, e.g., as shown in FIGS. 1 and 4. In aspects, the first and second stage after-treatment components are distinct enclosures each configured for reducing undesired emissions in their corresponding non-linear pathways, the distinct enclosures being fixed together with one or more attachments, e.g., brackets, flanges, and fasteners, e.g., as depicted in FIG. 1.

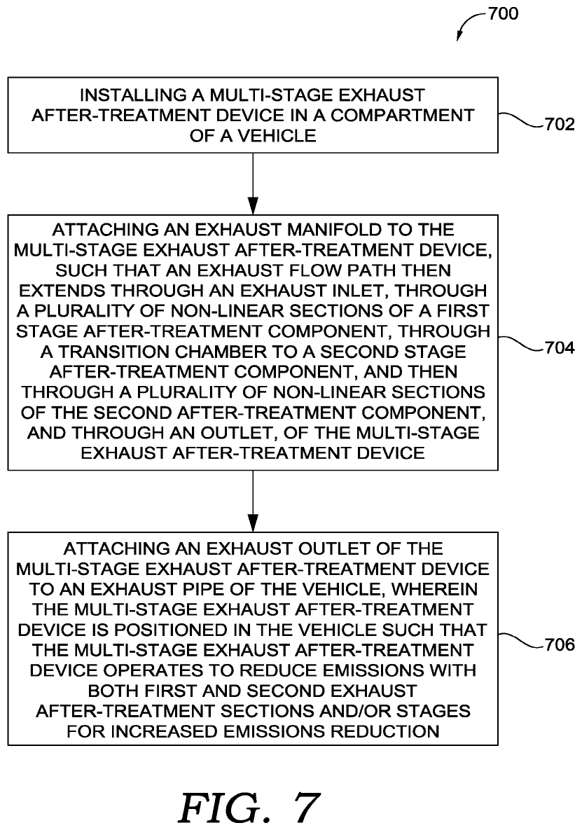

FIG. 7 depicts a block diagram of a method 700 of installing a multi-stage exhaust after-treatment device in a vehicle, e.g., the vehicle 500, according to aspects of the present disclosure. The method 700 includes blocks 702-706 but is not limited to this selection of elements or the order depicted. In block 702, the method 700 includes installing a multi-stage exhaust after-treatment device, e.g., the device 10 shown in FIG. 1, in an internal compartment of a vehicle, e.g., such as a compartment inside the vehicle 500. In block 704, the method 700 includes attaching an exhaust manifold to the multi-stage exhaust after-treatment device, such that an exhaust flow path then extends through an exhaust inlet, through a plurality of non-linear sections of a first stage after-treatment component, and then through a transition chamber to a second stage after-treatment component, and then through a plurality of non-linear sections of the second stage after-treatment component. In block 706, the method 700 includes attaching an exhaust outlet of the second stage-after treatment component to an exhaust pipe of the vehicle, e.g., such as exhaust pipe 502, such that the multi-stage exhaust after-treatment device operates to reduce emissions in emitted exhaust.

In one aspect, a method of operating a vehicle comprising an engine and a multi-stage exhaust after-treatment device comprising a first stage after-treatment component extending to a transition chamber extending to a second stage after-treatment component is provided. The method includes operating the engine; communicating exhaust from the engine through an inlet of the first stage after-treatment component; communicating the exhaust through a non-linear upper pathway of the first stage after-treatment component to the transition chamber; communicating the exhaust through the transition chamber to the second stage after-treatment component, communicating the exhaust through a non-linear lower pathway of the second stage after-treatment component; and communicating the exhaust from the non-linear lower pathway to an outlet, wherein the first stage after-treatment component and the second stage after-treatment component comprise distinct structures arranged in a stacked configuration along a vertical axis of the vehicle, the inlet and the outlet being offset along the vertical axis of the vehicle. In aspects, a method of operating a fleet of vehicles that each include a multi-stage exhaust after-treatment device according to aspects described herein is also provided. In aspects, a method of installing an exhaust after treatment system is provided, the method comprising: installing inside a vehicle a multi-stage exhaust after-treatment device comprising a first stage after-treatment component extending to a transition chamber extending to a second stage after-treatment component; and attaching the multi-stage exhaust after-treatment device to an engine and to an exhaust system.

In aspects, a kit including a multi-stage exhaust after-treatment device and/or components associated with the same may be provided for installation on a vehicle in place of an existing exhaust after-treatment device (e.g., single stage or multi-stage).

In aspects herein, a first stage after-treatment component is frequently described as being positioned over a top surface of a second stage after-treatment component as it relates to a vertical axis and/or an installed position, e.g., as in connection with the device 10 in FIG. 1. However, in aspects, the reverse configuration may instead be used with the second stage positioned over a top surface of the first stage, depending on the desired configuration and, e.g., the arrangement of the associated engine and exhaust pathway.

### EXAMPLE AFTER-TREATMENT SYSTEM

Referring back to FIG. 1, the following sections describe a non-limiting example of an exhaust gas after-treatment system (“ATS”), also referred to herein as the multi-stage exhaust after-treatment device 10. In aspects, the ATS is comprised of multiple elements and functions which can include:
1. “SCR”: selective catalytic reduction, e.g., associated with the second-stage after-treatment component 14;
2. “Pre-SCR”: pre-treatment selective catalytic reduction, e.g., associated with the first-stage after-treatment component 12;
3. “DOC”: diesel oxidation catalyst, also referred to herein as catalyst 70;
4. “DPF”: diesel particulate filter, also referred to herein as filter 74;
5. “AMOX”: ammonia oxide, e.g., a catalyst associated with the second-stage after-treatment component 14
6. “HC”: hydrocarbons, which can be injected by injection device 54 and its injector 55; and
7. “DEF”: diesel exhaust fluid, which can be injected by diesel exhaust fluid injection component 40 and its injector 41.

In one configuration, exhaust first passes through a Pre-SCR module or first stage after-treatment component 12, then in the second stage after-treatment component 14 where the exhaust passes through a DOC or catalyst 70 and DPF or filter 74, and then passes through SCR catalysts, and then finally passes through zone-coated SCR/AMOX catalysts. The ATS can include a single leg Pre-SCR, DOC/DPF and a dual leg SCR/AMOX. And, as described above, the system can include sensors for monitoring temperatures and pressures and can include components and control algorithms for HC dosing and DEF dosing. The system can include dual DEF dosing, as well as HC dosing locations.

The ATS, or multi-stage exhaust after-treatment device 10, can comprise a Pre-SCR module (or first stage after-treatment component 12) combined with a main box DOC/DPF, SCR system (or second stage after-treatment component 14). The Pre-SCR can be mounted on top of (or below) the main box with exhaust gas flowing through the module prior to entering the main box. The purpose of the Pre-SCR module is to treat exhaust gas in order to provide an initial reduction in NOx emissions. The Pre-SCR also serves as an injection point for hydrocarbon dosing, which is needed for active DPF regeneration, HC cleanup, and DEF deposit cleanup. The main box serves to remove particulates in the exhaust gas, as well as to further reduce NOx emissions.

### After-Treatment Configurations-Pre-SCR

Referring back to FIGS. 2A-2D and 3A-3E, the Pre-SCR module, or first-stage after-treatment component 12, features the exhaust gas flow path (in dashed lines) shown in FIG. 2A. The exhaust gas enters the module after exiting the engine turbocharger and S-Pipe. DEF is injected into the exhaust gas at a Pre-SCR DEF Injection Point by the injection component 40. Exhaust flow then continues through the exhaust treatment section 42 that defines a DEF Hydrolysis Pipe, where the liquid DEF is evaporated and thoroughly mixed with the gas. The exhaust treatment section 42 or DEF hydrolysis pipe exits into the exhaust treatment section 44 that includes a Pre-SCR Catalyst, where NOx is reduced. The treated exhaust gas then exits into the transition chamber 16 leading to the main box inlet. During active regeneration of the DPF module or exhaust treatment section 72, HC cleanup or DEF deposit cleanup, hydrocarbons are injected into the exhaust flow at a Pre-SCR Hydrocarbon Injection Point by the injection device 54. The Pre-SCR Hydrocarbon Injection Point at which the injection device 54 is located is downstream of the Pre-SCR catalyst in the exhaust treatment section 44. The hydrocarbons are evaporated and mixed into the exhaust gas as it flows through the Pre-SCR outlet and into the main box inlet chamber, before entering the DOC substrate.

### After-Treatment Configurations—Main Box

Referring to FIGS. 3C, 3D, and 3E, the after-treatment system DOC (or exhaust treatment section 68) and DPF (or exhaust treatment section 72) can be packaged in a common housing with the SCR and AMOX catalysts. In the main box or second stage after-treatment component 14, exhaust flows first through the DOC/DPF channel with flow exiting into an outlet plenum. The flow from the outlet plenum of the DOC/DPF passes injection component 66, or DEF injection point where DEF is injected into the flow 32, and enters a single hydrolysis pipe 77, e.g., in the exhaust treatment section 76, where the DEF and exhaust gas mix. The hydrolysis pipe 77 exits into a plenum that feeds the exhaust treatment section 60 having two SCR/AMOX channels with the flow 32 exiting from each channel into a common outlet plenum before exiting the SCR/AMOX assembly. Each of the two SCR/AMOX channels contains two catalyst bricks, e.g., substrates 78 and 80 mentioned above. The first brick contains SCR catalyst while the second brick is zone coated with the upstream half containing SCR catalyst and the downstream half containing a precious metal AMOX.

TABLE 1 below summarizes example Pre-SCR, DOC, DPF, SCR, and AMOX catalyst materials and catalysts. In aspects, the substrate material for the Pre-SCR, DOC, SCR, and SCR/AMOX catalysts is ceramic cordierite while the DPF substrate material is Aluminum Titanate. The DOC is a flow-through design, while the DPF is a wall-flow design with the channel walls serving as the filtering media. The Pre-SCR, SCR, and AMOX substrates are flow-through designs. In general, the DOC and DPF catalyst formulations enhance passive regeneration to achieve longer operating periods between required regenerations. The Pre-SCR and SCR catalysts contain iron/copper zeolite. The AMOX cleanup catalyst is precious metal coated.

TABLE 1
Catalyst Specifications

| | | SCR/ | | | | SCR/ |
|---|---|---|---|---|---|---|
| | Pre-SCR | ASC | DOC | cDPF | SCR | AMOX |
| Diameter and/or | 9-11 × 7-9 | 9-11 × 7-9 | 12-14 | 12-14 | 9-12 | 9-12 |
| cross-sectional area | | | | | | |
| [″] | | | | | | |
| Length [″] | 4-7 | 4-7 | 4-7 | 8-10 | 5-7 | 5-7 |
| No. of substrate legs | 1-2 | 1-2 | 1-2 | 1-2 | 1-3 | 1-3 |
| [—] | | | | | | |
| Volume | 4-8 | 4-8 | 10-13 | 18-21 | 16-20 | 16-20 |
| implemented [l] | | | | | | |
| (total 2-legs) | | | | | | |
| Substrate/Filter | Cordierite | Cordierite | Cordierite | AT | Cordierite | Cordierite |
| material | | | | | | |
| aSubstrate type | Celcor | Celcor | Celcor | DuraTrap ® | Celcor | Celcor |
| | LFA | LFA | LFA | | LFA | LFA |
| Cell density [cpsi] | 250-300 | 250-300 | 350-450 | 350-450 | 500-700 | 500-700 |
| Wall thickness [mil] | 5-7 | 5-7 | 4-6 | 6-8 | 3-5 | 3-5 |
| Coating Type | Cu- | Cu- | PT/Pd | Pt/Pd | Fe/Cu | Cu-Zeolite |
| | Zeolite | Zeolite | | | Zeolite | based |

The example ATS can include sensors for monitoring pressure and temperatures in the ATS assembly. A pressure sensor is located at the inlet to the Pre-SCR module. A delta pressure sensor is connected to the plenum that feeds flow to the DOC/DPF and the outlet of the DPF. Temperature sensors can be located in the following positions: Pre-SCR inlet and outlet, upstream of the DOC, another one between the DOC and DPF, one after the DPF, and the last downstream of the SCR. The delta pressure sensor can detect gross levels of filter plugging in the event that a malfunction causes overloading of the DPF. The pressure sensor also serves as input to diagnostics that detect pressure drop that is characteristic of certain DPF failure modes and of a missing DPF. During DPF regeneration, the temperature sensors upstream and downstream of the DOC and downstream of the DPF are used for management of HC dosing and detection of certain failure modes. Additionally, a soot sensor is located downstream of the SCR that can be used exclusively for diagnostic purposes.

### DEF Dosing System

The purpose of the DEF dosing system is to supply an adequate quantity of DEF to the Pre-SCR and SCR catalysts to support desired NOx reduction while minimizing slip of ammonia past the SCR catalysts. There can be two DEF dosers located on the ATS. The first DEF doser, e.g., injection component 40, is attached to the Pre-SCR module and the second DEF does, e.g., injection component 66, is attached to the main box or second stage after-treatment component 14. The DEF is stored in a supply tank attached to the vehicle chassis. An electrically driven DEF pump supplies DEF through a supply tube to the DEF doser assembly. The DEF doser assembly includes a PWM (pulse-width modulated) controlled doser supply valve that is modulated by an after-treatment control module (ACM) controller to provide the calculated quantity of DEF to the supply line that feeds DEF to the Pre-SCR and SCR catalysts. The ACM is attached to the after-treatment main box. The ACM controller determines the level of modulation of the DEF dosing valve necessary to achieve the desired DEF injection rate.

Temperature sensors can be located in each of the ATS plenums upstream and downstream of the Pre-SCR and SCR/AMOX catalyst that are used as inputs to the DEF dosing system control algorithms. DEF dosing rate can be influenced by the temperature-dependent SCR capacity for ammonia storage. The system can contain three NOx sensors. The first can be located upstream of the Pre-SCR catalyst. A NOx sensor is located upstream of the DPF. The next NOx sensor can be located downstream of the SCR catalysts. All sensors can be used for SCR system diagnostics, dosing control algorithms, and driver warnings and inducements upon detection of contaminated DEF. The DEF dosing system control logic includes an NH3 storage-slip model that utilizes SCR temperatures, engine-out NOx level, and other inputs to calculate the appropriate level of DEF injection based on parameters including NH3 consumption, NH3 storage, NH3 slippage and conversion efficiency.

A temperature sensor can be located inside of the DEF supply tank, a pressure sensor can be located in the DEF doser assembly, and a DEF pump speed sensor can be located in the DEF pump assembly, a DEF level sensor, and a urea quality sensor are located in the DEF supply tank. These sensors can be used as inputs to diagnostics, as inputs to DEF dosing control strategies such as DEF dosing prevention when DEF is frozen, and as inputs to DEF supply related driver warnings and inducements.

### Hydrocarbon (HC) Dosing System

The Hydrocarbon (HC) Doser system, e.g., including injection device 54, is configured to inject a precise amount of fuel into the exhaust upstream of the DOC to generate the required temperature rise for regeneration of the DPF. HC dosing is also used for after-treatment HC accumulation cleanup as part of the ATS HC Storage Cleanup and DEF Deposit Cleanup. The HC Doser includes a metering unit, hydrocarbon injection valve (HCIV) (e.g., injection device 54 and injector 55), and a fuel line that connects the metering unit and the HCIV. The metering unit can receive fuel from the engine's low pressure fuel circuit and can meter it during regeneration. The fuel line transfers the fuel to the HCIV which injects the fuel into the exhaust system when the supply pressure exceeds the opening pressure of the HCIV.

The metering unit can include a Fuel Cutoff Valve (FCV) which is a solenoid valve that ensures that fuel does not enter the exhaust stream should the second valve, the Diesel Dosing Valve (DDV), fail to open. An HC doser inlet pressure sensor, located between these two valves, provides feedback to the motor control module (MCM) for control of the HC dosing fuel flow rate while the DDV meters fuel delivery to the HCIV. A pressure sensor downstream of the DDV can be used to perform functional checks of the metering unit sub-components as well as the fuel line and HCIV. A housing contains the above components and sub-components.

When the ACM determines that a DPF regeneration, HC cleanup or DEF deposit cleanup needs to take place, the active regeneration mode is applied during which HC dosing may be required to reach desired temperatures. When operating at speeds and loads where normal exhaust temperature would otherwise be below temperature targets, regeneration mode set-points help increase the DOC-in exhaust temperature to the target for oxidizing the atomized fuel injected by the HCIV ahead of the DOC. The heat release from oxidation of fuel in the DOC will help raise exhaust gas temperatures downstream of the DOC to the correct target temperature for regeneration to occur. Based on calculated exhaust mass flow rate, the MCM uses a specific fuel flow rate. This feeds into a lookup table used to command output PWM percentage to the DDV. The FCV is commanded to open and the DDV regulates fuel flow according to the MCM PWM command. Fuel flows through the FCV, past the HC doser pressure sensor, is metered through the DDV and then travels past the outlet pressure sensor, through the fuel line and finally to the HCIV. Once pressure upstream of the HCIV rises above the valve opening pressure, fuel is injected into the exhaust stream ahead of the DOC.

The MCM can monitor the fuel supply pressure sensor and the DOC inlet pressure sensor to modify the PWM percentage based on the differential pressure. The fuel flow rate of the HC Dosing system is roughly proportional to fuel differential pressure so an increase in differential fuel pressure requires a lower PWM percentage to achieve the same nominal fuel flow rate and vice-versa.

The fuel injected by the HCIV can vary through the course of the regeneration event to control temperature and therefore soot oxidation rate. The regeneration event can end when sufficient effective dosing time has occurred to have regenerated the DPF or the soot level model reaches its lower threshold value. The HC dosing rate is calibrated to control DPF temperatures within design limits.

HC dosing may be interrupted under certain operating conditions such as when engine speed and load are normally attaining the desired temperature for the regeneration mode, and/or when operating conditions are such that the engine set-points cannot be practically set to achieve the desired exhaust temperature for HC dosing. When operating conditions require or allow HC dosing to recommence, then the above described HC dosing will continue.

The MCM can also perform integrity checks of dosing system components by monitoring the pressure sensors simultaneously with a sequence of valve closing and opening commands.

### EXAMPLE CLAUSES

Clause 1: A multi-stage exhaust after-treatment device having a longitudinal axis, a lateral axis, and a vertical axis, and comprising: an exhaust inlet; a first stage after-treatment component positioned downstream of the exhaust inlet and comprising; a first inlet, a plurality of exhaust treatment sections extending along a non-linear path, and a first outlet; a second stage after-treatment component positioned downstream of the first stage after-treatment component and comprising: a second inlet, a main enclosure, and a second outlet, wherein the first stage after-treatment component is attached over a top surface of the second stage after-treatment component thereby forming a vertically-stacked configuration of the first and second stage after-treatment components; and a transition chamber extending from the first outlet to the second inlet allowing exhaust from the first stage after-treatment component to be communicated to the second stage after-treatment component; or a multi-stage exhaust after-treatment device comprising: a first stage after-treatment component comprising a plurality of exhaust treatment sections extending along a non-linear path, including a diesel exhaust fluid injector configured to inject diesel exhaust fluid; and a second stage after-treatment component positioned downstream of the first stage after-treatment component having a diesel oxidation catalyst; wherein the first stage after-treatment component is attached over a top surface of the second stage after-treatment component; and a transition chamber fluidly connecting the first stage after-treatment component to the second stage after-treatment component so as to allow exhaust from the first stage after-treatment component to be communicated to the second stage after-treatment component.
Clause 2: The multi-stage exhaust after-treatment device of clause 1, wherein the first stage after-treatment component comprises a first distinct enclosure defining an upper exhaust pathway and the second stage after-treatment component comprises a second distinct enclosure enclosing a lower exhaust pathway.
Clause 3: The multi-stage exhaust after-treatment device of clause 1 or 2, wherein the first stage after-treatment component is attached to the second stage after-treatment component with a plurality of brackets coupled to a plurality of flanges; or
the multi-stage exhaust after-treatment device of clause 1 or 2, wherein the first stage after-treatment component comprises: a first exhaust treatment section of the plurality of exhaust treatment sections having the diesel exhaust fluid injector configured to inject the diesel exhaust fluid into the first exhaust treatment section; a third exhaust treatment section of the plurality of exhaust treatment sections having a catalyst substrate; and a second exhaust treatment section of the plurality of exhaust treatment defining a conduit fluidly connecting the first exhaust treatment section and the third exhaust treatment section, wherein the conduit is configured to space apart the first exhaust treatment section and the third exhaust treatment section; and/or wherein the conduit defined by the second exhaust treatment section is configured to allow diesel exhaust fluid hydrolysis to occur.
Clause 4: The multi-stage exhaust after-treatment device of any of clauses 1-3, wherein the plurality of exhaust treatment sections extend in a U-shape about the top surface of the second stage after-treatment component.
Clause 5: The multi-stage exhaust after-treatment device of any of clauses 1-4, wherein an exhaust inlet and a first inlet of the first stage after-treatment component are offset such that the first inlet is positioned closer to the top surface than the exhaust inlet.
Clause 6: The multi-stage exhaust after-treatment device of any of clauses 1-5, wherein an axis of an exhaust inlet and an axis of a first inlet of the first stage after-treatment component are non-parallel, such that a conduit extending from the exhaust inlet curves into the first inlet.
Clause 7: The multi-stage exhaust after-treatment device of any of clauses 1-6, wherein the transition chamber extends at least partially over a forward end of the multi-stage exhaust after-treatment device and along the vertical axis.
Clause 8: The multi-stage exhaust after-treatment device of any of clauses 1-7, wherein the transition chamber comprises an inlet having a first diameter and/or cross-sectional area and an outlet having a second diameter and/or cross-sectional area, the first diameter and/or cross-sectional area being larger than the second diameter and/or cross-sectional area.
Clause 9: The multi-stage exhaust after-treatment device of any of clauses 1-8, wherein an inlet of the transition chamber and an outlet of the transition chamber are oriented at a non-parallel angle, wherein a diameter and/or cross-sectional area of the transition chamber changes along a flow path through the transition chamber, and wherein the outlet of the transition chamber is coupled to an expansion chamber.
Clause 10: The multi-stage exhaust after-treatment device of any of clauses 1-9, wherein the transition chamber comprises: a mixing structure therein; and an injection component attached to the transition chamber for injecting hydrocarbons into the transition chamber.
Clause 11: The multi-stage exhaust after-treatment device of any of clauses 1-10, wherein the mixing structure comprises a plate with a plurality of openings.
Clause 12: The multi-stage exhaust after-treatment device of any of clauses 1-11, wherein at least one of the plurality of exhaust treatment sections is configured for injection of diesel exhaust fluid.
Clause 13: The multi-stage exhaust after-treatment device of any of clauses 1-12, wherein at least one of the plurality of exhaust treatment sections is configured for hydrolysis of diesel exhaust fluid.
Clause 14: The multi-stage exhaust after-treatment device of any of clauses 1-13, wherein at least one of the plurality of exhaust treatment sections comprises a catalyst substrate.
Clause 15: A vehicle comprising the multi-stage exhaust after-treatment device of any of clauses 1-14.
Clause 16: A vehicle, comprising: an engine; and a multi-stage exhaust after-treatment device, comprising: an exhaust inlet coupled to the engine; a first stage after-treatment component configured to reduce emissions in exhaust communicated from the engine through the first stage after-treatment component; a transition chamber that communicates the exhaust from the first stage after-treatment component to a second stage after-treatment component; the second stage after-treatment component configured to reduce emissions in the exhaust communicated from the transition chamber through the second stage after-treatment component, wherein the first stage after-treatment component and the second stage after-treatment component comprise distinct enclosures connected by the transition chamber, and wherein the first stage after-treatment component is attached over a top surface of the second stage after-treatment component such that the first stage after-treatment component and the second stage after-treatment component form a vertically-stacked configuration within the vehicle; and an exhaust outlet coupled to a tailpipe; or
a vehicle, comprising: an exhaust inlet coupled to an engine; and a multi-stage exhaust after-treatment device, comprising: a first stage after-treatment component configured to reduce emissions in exhaust communicated from the engine through the first stage after-treatment component; a transition chamber that communicates the exhaust from the first stage after-treatment component to a second stage after-treatment component; and the second stage after-treatment component configured to reduce emissions in the exhaust communicated from the transition chamber through the second stage after-treatment component, wherein the first stage after-treatment component and the second stage after-treatment component comprise distinct enclosures connected by the transition chamber, and wherein the first stage after-treatment component is attached over a top surface of the second stage after-treatment component
Clause 17: The vehicle of clause 16, wherein the first stage after-treatment component comprises a plurality of exhaust treatment sections that extend in a non-linear path about the top surface of the second stage after-treatment component, each exhaust treatment section configured to perform a different type of emissions reduction.
Clause 18: The vehicle of clause 16 or 17, wherein the first stage after-treatment component is attached to the top surface of the second stage after-treatment component with a plurality of brackets, each bracket coupled to a corresponding flange extending from the second stage after-treatment component.
Clause 19: The vehicle of any of clauses 16-18, wherein the transition chamber comprises: a mixing structure therein; and an injection component that injects hydrocarbons into the transition chamber, wherein the transition chamber extends over and vertically down a forward end of the multi-stage exhaust after-treatment device.
Clause 20: The vehicle of any of clauses 16-19, wherein the first stage after-treatment component comprises a diesel exhaust fluid injection section, a diesel exhaust fluid hydrolysis section, and a catalyst section arranged in a non-linear configuration with at least one transition in flow path diameter and/or cross-sectional area.
Clause 21: The vehicle of any of clauses 16-20, wherein the engine is a diesel engine, and wherein the vehicle is a freight tractor.
Clause 22: A fleet of freight vehicles, each comprising: a diesel engine; a multi-stage exhaust after-treatment device comprising: an exhaust inlet coupled to the diesel engine; a first stage after-treatment component configured to reduce emissions in exhaust communicated from the engine through the first stage after-treatment component; a transition chamber that communicates the exhaust from the first stage after-treatment component to a second stage after-treatment component; the second stage after-treatment component configured to reduce emissions in the exhaust communicated from the transition chamber through the second stage after-treatment component, wherein the first stage after-treatment component is attached over a top surface of the second stage after-treatment component such that the first stage after-treatment component and the second stage after-treatment component form a vertically-stacked configuration inside the vehicle; and an exhaust outlet coupled to a tailpipe.
Clause 23: The fleet of freight vehicles of clause 22, wherein the first stage after-treatment component and the second stage after-treatment component comprise distinct enclosures with the first stage after-treatment component defining an upper exhaust pathway that is non-linear and the second stage after-treatment component enclosing a lower exhaust pathway that is non-linear, wherein a flow path out of the first after-treatment component and a flow path into the second after-treatment component are oriented in substantially opposite directions.

In some aspects, this disclosure may include the language, for example, “at least one of [element A] and [element B].” This language may refer to one or more of the elements. For example, “at least one of A and B” may refer to “A,” “B,” or “A and B.” In other words, “at least one of A and B” may refer to “at least one of A and at least one of B,” or “at least either of A or B.” In some aspects, this disclosure may include the language, for example, “[element A], [element B], and/or [element C].” This language may refer to either of the elements or any combination thereof. In other words, “A, B, and/or C” may refer to “A,” “B,” “C,” “A and B,” “A and C,” “B and C,” or “A, B, and C.” In addition, this disclosure may use the term “and/or” which may refer to any one or combination of the associated elements. In addition, this disclosure may use the term “a” (element) or “the” (element). This language may refer to the referenced element in the singular or in the plural and is not intended to be limiting in this respect.

The subject matter of this disclosure has been described in relation to particular aspects, which are intended in all respects to be illustrative rather than restrictive. In this sense, alternative aspects will become apparent to those of ordinary skill in the art to which the present subject matter pertains without departing from the scope hereof. In addition, different combinations and sub-combinations of elements disclosed, as well as use and inclusion of elements not shown, are possible and contemplated as well.

This detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar to those described in this disclosure, and in conjunction with other present or future technologies or solutions. Moreover, although the terms “step” or “block” may be used herein to identify different elements of methods employed, the terms should not be interpreted as implying any particular order among or between different elements except when the order is explicitly stated.

1. A multi-stage exhaust after-treatment device, comprising:
a first stage after-treatment component comprising a plurality of exhaust treatment sections extending along a non-linear path, including a diesel exhaust fluid injector configured to inject diesel exhaust fluid; and
a second stage after-treatment component positioned downstream of the first stage after-treatment component having a diesel oxidation catalyst;
wherein the first stage after-treatment component is attached over a top surface of the second stage after-treatment component; and
a transition chamber fluidly connecting the first stage after-treatment component to the second stage after-treatment component so as to allow exhaust from the first stage after-treatment component to be communicated to the second stage after-treatment component.

2. The multi-stage exhaust after-treatment device of claim 1, wherein the first stage after-treatment component comprises a first distinct enclosure defining an upper exhaust pathway and the second stage after-treatment component comprises a second distinct enclosure enclosing a lower exhaust pathway.

3. The multi-stage exhaust after-treatment device of claim 1, wherein the first stage after-treatment component comprises:
a first exhaust treatment section of the plurality of exhaust treatment sections having the diesel exhaust fluid injector configured to inject the diesel exhaust fluid into the first exhaust treatment section;
a third exhaust treatment section of the plurality of exhaust treatment sections having a catalyst substrate; and
a second exhaust treatment section of the plurality of exhaust treatment defining a conduit fluidly connecting the first exhaust treatment section and the third exhaust treatment section, wherein the conduit is configured to space apart the first exhaust treatment section and the third exhaust treatment section.

4. The multi-stage exhaust after-treatment device of claim 3, wherein the conduit defined by the second exhaust treatment section is configured to allow diesel exhaust fluid hydrolysis to occur.

5. The multi-stage exhaust after-treatment device of claim 1, wherein the plurality of exhaust treatment sections extend in a U-shape about the top surface of the second stage after-treatment component.

6. The multi-stage exhaust after-treatment device of claim 1, wherein an exhaust inlet and a first inlet of the first stage after-treatment component are offset such that the first inlet is positioned closer to the top surface than the exhaust inlet.

7. The multi-stage exhaust after-treatment device of claim 1, wherein an axis of an exhaust inlet and an axis of a first inlet of the first stage after-treatment component are non-parallel, such that a conduit extending from the exhaust inlet curves into the first inlet.

8. The multi-stage exhaust after-treatment device of claim 1, wherein the transition chamber extends at least partially over a forward end of the multi-stage exhaust after-treatment device and along a vertical axis.

9. The multi-stage exhaust after-treatment device of claim 1, wherein the transition chamber comprises an inlet having a first cross-sectional area and an outlet having a second cross-sectional area, the first cross-sectional area being larger than the second cross-sectional area.

10. The multi-stage exhaust after-treatment device of claim 1, wherein an inlet of the transition chamber and an outlet of the transition chamber are oriented at a non-parallel angle, wherein a cross-sectional area of the transition chamber changes along a flow path through the transition chamber, and wherein the outlet of the transition chamber is coupled to an expansion chamber.

11. The multi-stage exhaust after-treatment device of claim 1, wherein the transition chamber comprises:
a mixing structure therein; and
an injection component attached to the transition chamber for injecting hydrocarbons into the transition chamber.

12. The multi-stage exhaust after-treatment device of claim 11, wherein the mixing structure comprises a plate with a plurality of openings.

13. The multi-stage exhaust after-treatment device of claim 1, wherein at least one of the plurality of exhaust treatment sections is configured for injection of diesel exhaust fluid.

14. The multi-stage exhaust after-treatment device of claim 1, wherein at least one of the plurality of exhaust treatment sections is configured for hydrolysis of diesel exhaust fluid.

15. The multi-stage exhaust after-treatment device of claim 1, wherein at least one of the plurality of exhaust treatment sections comprises a catalyst substrate.

16. A vehicle, comprising:
an exhaust inlet coupled to an engine; and
a multi-stage exhaust after-treatment device, comprising:
a first stage after-treatment component configured to reduce emissions in exhaust communicated from the engine through the first stage after-treatment component;
a transition chamber that communicates the exhaust from the first stage after-treatment component to a second stage after-treatment component; and
the second stage after-treatment component configured to reduce emissions in the exhaust communicated from the transition chamber through the second stage after-treatment component, wherein the first stage after-treatment component and the second stage after-treatment component comprise distinct enclosures connected by the transition chamber, and wherein the first stage after-treatment component is attached over a top surface of the second stage after-treatment component.

17. The vehicle of claim 16, wherein the first stage after-treatment component comprises a plurality of exhaust treatment sections that extend in a non-linear path about the top surface of the second stage after-treatment component, each exhaust treatment section configured to perform a different type of emissions reduction.

18. The vehicle of claim 17, wherein the first stage after-treatment component comprises:
a first exhaust treatment section of the plurality of exhaust treatment sections having the diesel exhaust fluid injector configured to inject the diesel exhaust fluid into the first exhaust treatment section;
a third exhaust treatment section of the plurality of exhaust treatment sections having a catalyst substrate; and
a second exhaust treatment section of the plurality of exhaust treatment defining a conduit fluidly connecting the first exhaust treatment section and the third exhaust treatment section, wherein the conduit is configured to space apart the first exhaust treatment section and the third exhaust treatment section.

19. The vehicle of claim 16, wherein the transition chamber comprises:
a mixing structure therein; and
an injection component that injects hydrocarbons into the transition chamber, wherein the transition chamber extends over and vertically down a forward end of the multi-stage exhaust after-treatment device.

20. The vehicle of claim 16, wherein the first stage after-treatment component comprises a diesel exhaust fluid injection section, a diesel exhaust fluid hydrolysis section, and a catalyst section arranged in a non-linear configuration with at least one transition in flow path cross-sectional area.
